(19) United States
(12) Patent Application Publication
(10) Pub. No.: US 2025/0240609 A1
(43) Pub. Date: Jul. 24, 2025

(54) COMMUNICATION CONTROL SYSTEM, COMMUNICATION CONTROL APPARATUS, AND COMMUNICATION CONTROL METHOD

(71) Applicant: NEC Corporation, Minato-ku, Tokyo (JP)

(72) Inventors: Kosei KOBAYASHI, Tokyo (JP); Yusuke SHINOHARA, Tokyo (JP); Takanori IWAI, Tokyo (JP); Hayato ITSUMI, Tokyo (JP); Koichi NIHEI, Tokyo (JP); Kazuki OGATA, Tokyo (JP); Kei YANAGISAWA, Tokyo (JP)

(73) Assignee: NEC Corporation, Minato-ku, Tokyo (JP)

(21) Appl. No.: 18/697,755

(22) PCT Filed: Oct. 20, 2021
(86) PCT No.: PCT/JP2021/038790

§ 371 Date: Apr. 2, 2024

(51) Int. Cl. H04W 4/50; H04W 28/02

(52) U.S. Cl. CPC H04W 4/50; H04W 28/0268

(57) ABSTRACT

It is possible to give a notification for coping with a factor that causes a bottleneck of a communication problem in a service provision system that provides a service from a provision source server to a mobile object. A communication control system or a communication control apparatus identifies a bottleneck of a communication problem in a service provision system that provides a service from a provision source server to a mobile object. A communication control system or a communication control apparatus decides a control method in accordance with the bottleneck identified by the identifying and notifies a notification destination serving as a main control entity that executes control by the control method of the control method decided by the decision.

### TECHNICAL FIELD

The present disclosure relates to a communication control system, a communication control apparatus, and a communication control method.

### BACKGROUND ART

As a related art, Patent Literature 1 discloses an edge host computer apparatus. The edge host computer apparatus predicts a response delay time of a specific service on the basis of a calculation delay time taken for information processing from reception of a request for the specific service to response and a communication delay time taken for communication between a terminal apparatus requesting the specific service and its own apparatus. The edge host computer apparatus decides an edge host computer apparatus that provides the specific service on the basis of the response delay time answered from another edge host computer apparatus and the response delay time of the prediction result. The edge host computer apparatus performs setting in such a way that the decided edge host computer apparatus provides the specific service.

As another related art, Patent Literature 2 discloses a monitoring system that includes a monitoring apparatus and a transfer apparatus and appropriately determines a congestion status of a specific network in packet communication. The transfer apparatus transfers a packet communicated between a user terminal and a server at a connection point between a first network on a user terminal side and a second network on a server side, and further transfers the packet to the monitoring apparatus. The monitoring apparatus analyzes the packet communicated between the user terminal and the server, and decides a packet loss of the packet transferred between the user terminal and the server in the first network on the basis of a result of the analysis. The monitoring apparatus determines whether the first network is a bottleneck on the basis of the packet loss in the first network. Further, the monitoring apparatus determines a packet loss of the packet transferred between the user terminal and the server in the second network based on a result of the analysis. The monitoring apparatus determines whether the second network is a bottleneck on the basis of the packet loss in the second network. Further, the monitoring apparatus is configured to be able to disclose the determination result in response to an instruction from the user terminal or a terminal of an administrator of a network.

As another related art, Patent Literature 3 discloses an information system that includes a plurality of application servers and database servers, and performs appropriate load control in accordance with a processing time of a transaction by each application server. The information system includes a processing time monitoring unit, a bottleneck identification unit, and a load control unit. The processing time monitoring unit monitors, for each application server, a processing time during which an application program processes a transaction received by the application server. The bottleneck identification unit identifies whether there is a bottleneck in the application server in which the processing time is not within a predetermined allowable range on the basis of the monitoring result of the processing time for each application server. The load control unit reduces the multiplicity of executing the application program on the application server identified as having the cause of the bottleneck.

### CITATION LIST

### Patent Literature

Patent Literature 1: Japanese Unexamined Patent Application Publication No. 2020-137067

Patent Literature 2: International Patent Publication No. WO2014/141785

Patent Literature 3: International Patent Publication No. WO2005/041038

### SUMMARY OF INVENTION

### Technical Problem

As described above, in the technique described in Patent Literature 1, the edge host computer apparatus decides the edge host computer apparatus to be connected to the terminal apparatus on the basis of the service response delay time including the calculation delay time and the communication delay time, and changes the connection destination. However, in the technique described in Patent Literature 1, switching of the edge host computer apparatus is merely executed on the basis of the service response delay time without identifying the delay factor, and thus, the fundamental delay factor is not eliminated.

Further, in the technique described in Patent Literature 2, the user or the network administrator can check, from the terminal, the determination result as to whether the first network is a bottleneck and whether the second network is a bottleneck. However, in the technique described in Patent Literature 2, although it is known which network is the bottleneck, it is necessary for the user or the network administrator to check the determination result and perform the network selection operation, and it is difficult to automatically cope with it on the system.

Further, in the technology described in Patent Literature 3, an application server having a bottleneck is identified on the basis of the monitoring result of the processing time for each application server, and the multiplicity of executing the application program on the identified server is reduced. However, the delay factor may include other factors such as a network delay in addition to the processing of the application server. Therefore, in the technology described in Patent Literature 3, there is a case in which it is difficult to cope by a single application server depending on the delay factor, and it is difficult to fundamentally cope with other factors such as a network delay.

In light of the above circumstances, it is an object of the present disclosure to provide a communication control system, a communication control apparatus, and a communication control method which are capable of giving a notification for causing a mobile object to cope with a factor that causes a bottleneck of a communication problem in a service provision system that provides a service from a provision source server.

### Solution to Problem

In order to achieve the above object, the present disclosure provides, as a first aspect, a communication control system. The communication control system includes an identification means for identifying a bottleneck of a communication problem in a service provision system that provides a service from a provision source server to a mobile object and a decision means for deciding a control method in accordance with the bottleneck identified by the identification means. The communication control system includes a notification means for notifying a notification destination serving as a main control entity that executes control by the control method of the control method decided by the decision means.

The present disclosure provides, as a second aspect, a communication control apparatus. The communication control apparatus includes an identification means for identifying a bottleneck of a communication problem in a service provision system that provides a service from a provision source server to a mobile object and a decision means for deciding a control method in accordance with the bottleneck identified by the identification means. The communication control apparatus includes a notification means for notifying a notification destination serving as a main control entity that executes control by the control method of the control method decided by the decision means.

The present disclosure provides, as a third aspect, a communication control method. The communication control method includes an identification process of identifying a bottleneck of a communication problem in a service provision system that provides a service from a provision source server to a mobile object and a decision process of deciding a control method in accordance with the bottleneck identified by the identification process. The communication control method includes a notification process of notifying a notification destination serving as a main control entity that executes control by the control method of the control method decided by the decision process.

### Advantageous Effects of Invention

According to the present disclosure, it is possible to provide a communication control system, a communication control apparatus, and a communication control method which are capable of giving a notification for causing a mobile object to cope with a factor that causes a bottleneck of a communication problem in a service provision system that provides a service from a provision source server.

### BRIEF DESCRIPTION OF DRAWINGS

FIG. 1 is a block diagram illustrating a configuration example of a communication control system according to a first example embodiment of the present disclosure.

FIG. 2 is a block diagram illustrating a communication control apparatus as a configuration example of the communication control system of FIG. 1.

FIG. 3 is a flowchart for explaining an example of a communication control method in the communication control system of FIG. 1 or the communication control apparatus of FIG. 2.

FIG. 4 is a block diagram illustrating another configuration example of the communication control system of FIG. 1.

FIG. 5 is a block diagram illustrating a configuration example of a mobile object in the configuration example of FIG. 4.

FIG. 6 is a flowchart for describing a processing example in the communication control system of FIG. 4.

FIG. 7 is a diagram illustrating an example of a correspondence relationship table used in the processing example of FIG. 6.

FIG. 8 is a block diagram illustrating still another configuration example of the communication control system in FIG. 1.

FIG. 9 is a block diagram illustrating still another configuration example of the communication control system in FIG. 1.

FIG. 10 is a flowchart for describing an example of a communication control method in a communication control system according to a second example embodiment of the present disclosure.

FIG. 11 is a block diagram illustrating a configuration example of a computer apparatus.

### EXAMPLE EMBODIMENT

Hereinafter, example embodiments according to the present disclosure will be described in detail with reference to the drawings. Note that omission and simplification are made as appropriate in the description and drawings described below for clarity of description. In addition, in each of the drawings described below, the same elements and similar elements are denoted by the same reference signs, and a duplicate description is omitted as necessary.

### First Example Embodiment

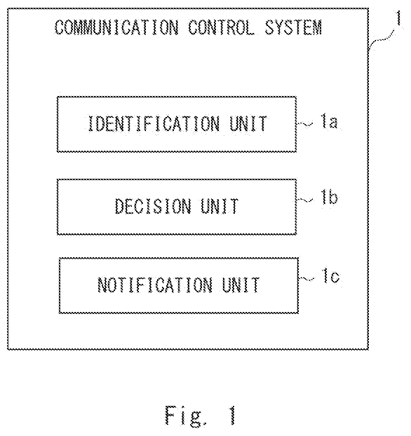

FIG. 1 is a block diagram illustrating a configuration example of a communication control system according to a first example embodiment of the present disclosure. As illustrated in FIG. 1, the communication control system 1 according to the present example embodiment may include an identification unit (identification means) 1a, a decision unit (decision means) 1b, and a notification unit (notification means) 1c.

The communication control system 1 can be provided in a service provision system that provides a service from a provision source server to a mobile object, and is a system for solving a communication problem in this service provision system.

The mobile object may be, for example, a pedestrian, a bicycle, an automobile (a taxi, a bus, a truck, or the like, and the purpose thereof does not matter), a work vehicle other than an automobile, or a ground vehicle such as a train. Further, the mobile object may be an object that moves under water or over water such as a ship or an underwater drone or an object (flying object) that moves in the air such as an aircraft or a flying drone. Furthermore, the mobile object may be a mobile robot such as an automated guided vehicle (AGV).

Further, it does not matter whether the mobile object has a function of moving according to autonomous control, a function of moving according to operation by an operator, or both functions. In a case in which the mobile object has a function of moving according to autonomous control, the mobile object performs automatic driving (autonomous driving) on the basis of information of a sensor mounted on the mobile object. Further, the mobile object may be configured to be able to switch between, for example, automatic driving and manual driving by an occupant (for example, a driver in a vehicle in the case of an automatic driving vehicle). In this case, the mobile object may switch from the manual driving to the automatic driving or from the automatic driving to the manual driving in response to an instruction transmitted from a provision source server, for example, as a driving-switching service provided from the provision source server.

Examples of the service include an emergency alert service such as collision, a traffic jam information distribution service, an approach notification service of an emergency vehicle, a dynamic map distribution service, the driving switching service, a music distribution service, and a video distribution service. Examples of the services include various types of services other than these services. The service may be mainly provided by, but is not limited to, an application program (hereinafter, “application”). Further, an information transmission direction may be from the provision source server to the mobile object or from the mobile object to the provision source server. That is, even in a case in which the provision source server is a service provision source, an information transmission source need not be necessarily the provision source server, and the information transmission source may be the mobile object. For example, in order to provide a video or an analysis result thereof to a third party by using a relay service provided by the provision source server, the video may be distributed from the mobile object to the provision source server.

The provision source server may be, but is not limited to, an edge server such as a multi-access edge computing (MEC) server installed at a position close to the mobile object in order to improve a processing speed including a communication delay. In other words, in order to reduce the communication delay, for example, the mobile object may select and communicate with the provision source server to be connected by control from the mobile object or other apparatuses, but a server that provides a service to the mobile object may be selected by a method other than such a selection method.

In the communication control system 1, the identification unit 1a, the decision unit 1b, and the notification unit 1c may be distributed and mounted on a plurality of apparatuses, and a distribution method thereof is not limited. For example, the communication control system 1 may be configured with an apparatus including the identification unit 1a, an apparatus including the decision unit 1b, and an apparatus including the notification unit 1c. Each apparatus may be configured as a computer apparatus including hardware including, for example, one or more processors and one or more memories. Then, at least some of functions of the units mounted in each apparatus may be implemented in such a way that one or more processors operate in accordance with a program read from one or more memories.

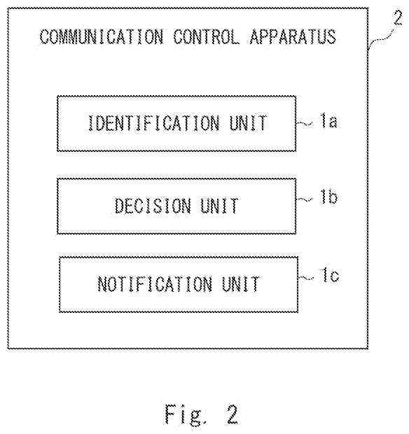

Further, as illustrated in FIG. 2, the communication control system 1 may be constructed as a single communication control apparatus 2 including the identification unit 1a, the decision unit 1b, and the notification unit 1c. FIG. 2 is a block diagram illustrating the communication control apparatus 2 which is a configuration example of the communication control system 1 of FIG. 1. The communication control apparatus 2 may be configured as a computer apparatus including hardware including, for example, one or more processors and one or more memories. Then, at least some of functions of the units mounted in the communication control apparatus 2 may be implemented in such a way that one or more processors operate in accordance with a program read from one or more memories. Further, the communication control apparatus 2 may be implemented in such a way that the functions of the respective units are distributed to separate apparatuses, and a distribution method thereof is not limited. For example, the communication control apparatus 2 may be configured with an apparatus including the identification unit 1a, an apparatus including the decision unit 1b, and an apparatus including the notification unit 1c.

Next, the respective units 1a to 1c will be described.

The identification unit 1a identifies the bottleneck of the communication problem in the service provision system that provides a service from the provision source server to the mobile object. The communication problem described above may mainly refer to a problem that a delay, a disconnection, or the like occurs in providing a service, and thus, the bottleneck of the communication problem may refer to a factor that becomes the bottleneck among the factors of the delay or the disconnection in providing such a service.

Examples of the factors such as the delay or the disconnection in providing the service include a traffic load in a wireless communication section, a high load or a failure of the provision source server, the mobile object, or the like, a wireless quality in a wireless communication section, and a physical distance between the provision source server and the mobile object.

Regardless of a method by which the identification unit la identifies the bottleneck of the communication problem or information used for identification, the bottleneck can be identified by various methods using various pieces of information. For example, the identification unit la identifies the bottleneck of the communication problem on the basis of information related to between the mobile object and the provision source server, between apparatuses included in the service provision system, or the like.

The information used for identifying the bottleneck is described as identification target information. Examples of the identification target information include information indicating a congestion status of a network, a time required for processing related to the service in each apparatus, a priority of processing related to the service in each apparatus, and a congestion status of processing in each apparatus. Of course, the identification target information may be information from which such information can be checked.

Here, the congestion status of the network can be checked by, for example, communication packet information indicating communication packets to be transmitted and received between apparatuses. For example, various types of information described in a header included in a communication packet, such as an Internet protocol (IP) address of a transmission source, an IP address of a destination, a port number, and a flag indicating contents of data, can be used as the communication packet information. Further, the time or priority required for processing related to the service in each apparatus or the degree of congestion of processing in each apparatus may be acquired from a target apparatus. Further, the physical distance between the provision source server and the mobile object can be calculated from information indicating the position of the provision source server stored in advance and position information indicating the position of the mobile object acquired from the mobile object.

Further, the identification unit la may identify the bottleneck at predetermined intervals, but may be configured to identify the bottleneck at a time point at which a predetermined criterion is satisfied, for example, at a time point at which some error occurs.

The decision unit 1b determines a control method in accordance with the bottleneck identified by the identification unit 1a. The control method decided here may be control policies or may include detailed control contents. Although an apparatus (main control entity) that executes control, as a main entity, in accordance with the control method decided by the decision unit 1b will be described as being decided by the notification unit 1c to be described later, the decision unit 1b may decide the main control entity together with the control method.

The control method decided by the decision unit 1b may include changing the priority of communication related to the service in order to lower the traffic load of communication related to other than the service in the target wireless communication section, and changing the wireless control method in order to improve the wireless quality in the target wireless communication section. Further, the control method may include relatively increasing the priority of an application related to the service in the target apparatus (the provision source server or the mobile object) in order to eliminate the high load of the provision source server or the mobile object. Further, the control method may include switching the provision source server to a server with a low processing load in order to eliminate a high load of the provision source server or to reduce a physical distance between the provision source server and the mobile object to reduce a network delay. As exemplified herein, the decision unit 1b decides the control method for eliminating the identified bottleneck.

Here, the process of switching the provision source server (hereinafter, “server switching process”) will be supplementarily described. The server switching process is a process of switching the provision source server from a server (also referred to as a switching source server) that currently provides the service to a server (also referred to as a switching destination server) that is a switching destination. The communication control system 1 or the communication control apparatus 2 may include a system having a function of performing the server switching process, and the description will proceed with this example, but this function is not essential, and the communication control system 1 or the communication control apparatus 2 may be provided in other systems connected to the communication control system 1 or the communication control apparatus 2. Further, the server switching process may be executed in the communication control system 1 or the communication control apparatus 2, for example, in accordance with movement of the mobile object, regardless of a scene executed as an example of the control method.

In a case in which the server switching process is executed, the server serving as the switching destination is decided, but basically, a certain criterion may be adopted as the server decision criterion such as selection of the switching destination server. Preferably, the switching destination server is decided on the basis of predetermined criteria, and for example, a server geographically closest to the mobile object may be decided as the switching destination server, or a server instructed to a certain server included in the communication control system 1 or other systems may be decided as the switching destination server. Further, a server on a cloud system may be decided as the switching destination server.

Further, the server switching process may be a process of providing, from the switching destination server, the service related to the service being provided from the switching source server to the mobile object. That is, the service may be changed before and after the server switching process. For example, there is a case in which non-similar services (for example, services whose provision sources are different, such as local public organizations) are provided depending on an area. In this example, in a case in which the physical distance from the provision source server increases as the mobile object moves across the areas, a service provided by an original area may be switched to a service provided by another equivalent area.

The notification unit 1c gives a notification indicating the control method decided by the decision unit 1b to the main control entity which performs control as a main entity by the control method. In practice, since it is also possible to assume that there is a plurality of main control entities capable of executing the decided control method, the main control entity that performs execution as a main entity, that is, the main control entity to which the notification unit 1c gives the notification will be described as a “notification destination” for distinction. Further, here, the description will proceed under the assumption that the main control entity that executes control by the above-described control method, that is, the notification destination is decided by the notification unit 1c.

The notification destination decided by the notification unit 1c is the main control entity that executes the control method decided by the decision unit 1b as a main entity, and basically differs depending on the control method. The candidates of the notification destination may include, for example, a core network of wireless communication used for providing a service (a core network system of a wireless communication network), a mobile object enjoying a service, a provision source server providing a service, or a switching destination server. Further, the candidates of the notification destination may include a management node such as the provision source server or the management server that manages the switching destination server, or the candidates of the notification destination may include an upper server when the upper server exists in the provision source server in the service provision system. Further, the number of hierarchies or the hierarchical structure of the servers for managing a plurality of servers that can be the provision sources are not limited. Further, the candidates of the notification destination may include an apparatus itself (other parts of the apparatus) provided with the notification unit 1c.

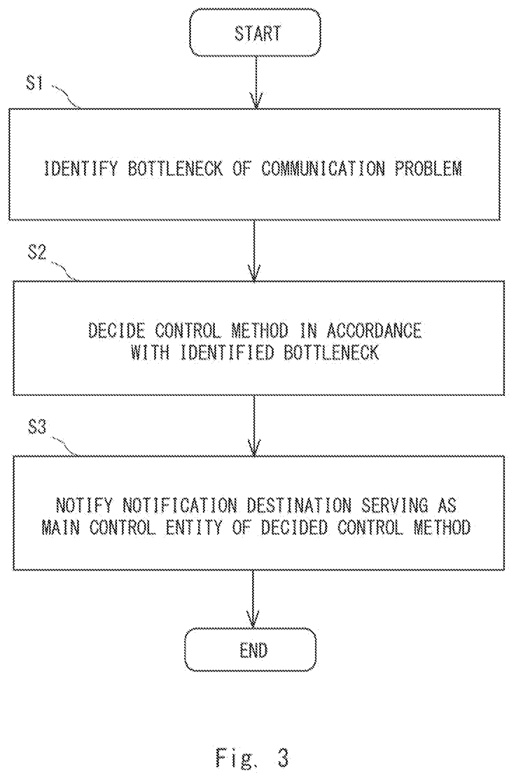

Next, a communication control method in the communication control system 1 or the communication control apparatus 2 having the above-described configuration will be described with reference to FIG. 3. FIG. 3 is a flowchart for explaining an example of the communication control method.

In this communication control method, first, the identification unit 1a executes an identification process of identifying the bottleneck of the communication problem in the service provision system that provides the service from the provision source server to the mobile object (step S1). Next, the decision unit 1b executes a decision process of deciding the control method in accordance with the bottleneck identified in the identification process (step S2). Then, the notification unit 1c executes a notification process of notifying the notification destination serving as the main control entity of the control method decided in the decision process (step S3).

On the basis of the notification of step S3, the main control entity that has received the notification executes the control method decided in the decision process to solve the communication problem that causes the bottleneck. Information indicating a type of control to be executed may be included in the notification, or a type of control to be executed may be decided in advance at a time point at which the notification is given in the notification destination.

The process of steps S1 to S3 may be executed at predetermined intervals, but the present disclosure is not limited thereto, and for example, the process may be executed on the basis of a predetermined criterion in such a way that the process is not performed for a certain period immediately after the server switching process is executed, or the process is performed only immediately after the server switching process is executed. Further, the process of steps S1 to S3 may be executed as one set until there is no factor that can be regarded as a bottleneck, and accordingly, it is possible to solve large communication problems in order.

As described above, in the present example embodiment, the bottleneck of the communication problem is identified, the control method associated with the identified bottleneck is decided, and the notification is given to the main control entity. Therefore, according to the present example embodiment, it is possible to give the notification for coping with the factor that causes the bottleneck of the communication problem in the service provision system that provides the service from the provision source server to the mobile object.

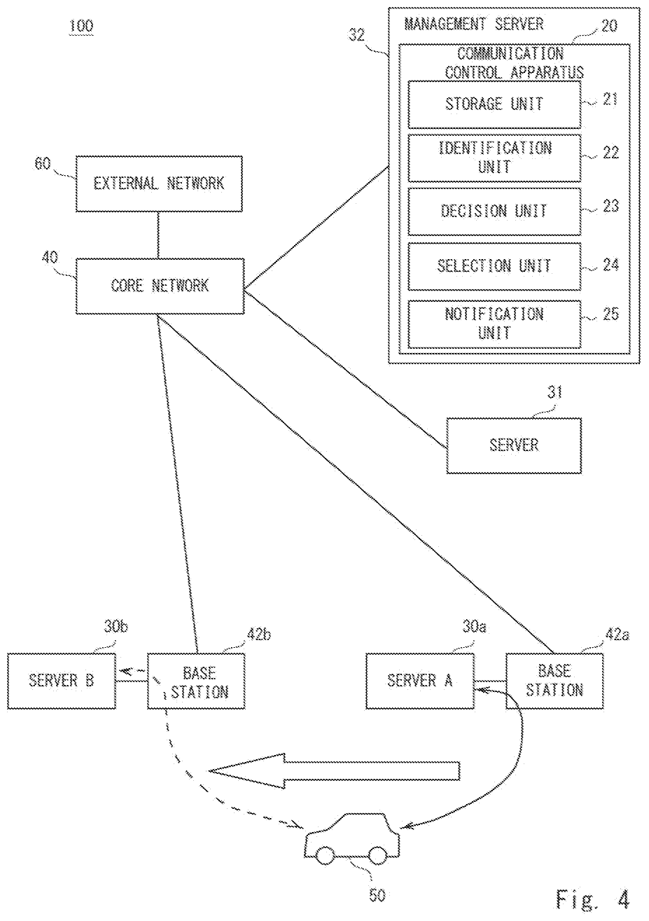

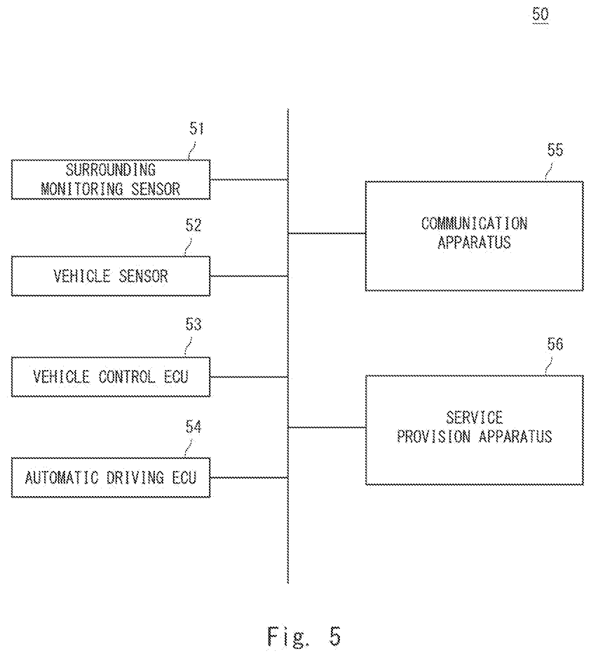

Next, another configuration example of the communication control system 1 of FIG. 1 will be described with reference to FIGS. 4 to 7 while describing a First, an overview of this configuration more specific operation example. example will be described with reference to FIGS. 4 and 5. FIG. 4 is a block diagram illustrating a configuration example of the communication control system 1 of FIG. 1 in a concept stage. FIG. 5 is a block diagram illustrating a configuration example of a mobile object in the configuration example of FIG. 4, and is a diagram mainly illustrating an information processing apparatus mounted on the mobile object.

A communication control system 100 illustrated in FIG. 4 includes a service provision system that provides the service from the provision source server to the mobile object 50, and includes a communication control apparatus 20 that is an example of the communication control apparatus 2, a core network 40, base stations 42a and 42b, and a server A 30a and a server B 30b arranged at two spots. The base stations 42a and 42b are wireless base stations or wireless relay stations that are connected to the core network 40 and perform wireless communication. In FIG. 4, a white arrow indicates the traveling direction of the mobile object 50.

The server A 30a and the server B 30b are servers capable of providing the services to the mobile object 50 (that is, the servers that can be a provision source), and are connected to the base station 42a and the base station 42b respectively connected to the communication control apparatus 20 via the core network 40. The base stations such as the base stations 42a and 42b connected to the servers such as the server A 30a and the server B 30b that can be service provision sources can be interspersed in units of intersections.

Of course, the communication control apparatus 20 may be connected to servers arranged at three or more spots. Further, the communication control system 100 may include a server 31 which is an example of the upper server of the server A 30a and the server B 30b, and the server 31 may be constructed so as to be able to provide the service to the mobile object 50. Here, the upper server described above is, for example, a server that manages information used when the server A 30a and the server B 30b provide the services, and is configured to be able to provide the services to the mobile object 50. Further, the communication control apparatus 20 may be connected to the server A 30a, the server B 30b, the server 31, or the like without going through the core network 40.

The following description will proceed with an example in which the server A 30a is the provision source server and the server B 30b is the switching destination server when the server switching process is executed. That is, in this example, the server A 30a and the server B 30b are different in that the server A 30a is a server that is currently providing the service to the mobile object 50, whereas the server B 30b is a server that is going to provide the service after switching as the switching destination.

Further, although not illustrated, in the communication control system 100, a camera (for example, a roadside camera installed on a road side) and a spot information transmission apparatus may be arranged at a spot at which the base station 42a connected to the server A 30a is installed or a spot at which the base station 42b connected to the server B 30b is installed. As described above, the communication control system 100 may include a device installed as a part of a traffic infrastructure, such as an information acquisition device installed on a route on which the mobile object 50 moves. However, the server, the spot information transmission apparatus, and the camera need not to be necessarily arranged at the same spot, and a geographical interval at which the server is installed may be different from a geographical interval at which the camera or the like is installed. Further, the server, the spot information transmission apparatus, and the camera may be connected to the communication control apparatus 20 via the same network, or may be connected to the communication control apparatus 20 via different networks.

Further, a plurality of mobile objects 50 may provide the services, and in this case, the communication control apparatus 20 may perform processing such as the identification of the bottleneck, the decision of the control method, and the notification of the main control entity for each of a set of the mobile object 50 and the provision source server.

Further, the communication control system 100 may include a management server 32 that comprehensively manages a plurality of servers that can be the provision source servers via the core network 40. For example, in a case in which the provision source server is a MEC server, the management server 32 may be a MEC orchestrator or the like. Further, FIG. 4 illustrates an example in which the communication control apparatus 20 is provided in the management server 32, but the management server 32 may be configured to include the function of the communication control apparatus 20 as a part of its function.

The core network 40 may include, for example, a fifth generation mobile communication system or a core network system of a wireless communication network using a communication line standard such as long term evolution (LTE) local 5G, 4G, or 3G. The core network 40 may be referred to as a 5th generation core network (5GC) in the case of a 5th generation mobile communication system. In the case of 5GC, a gNB (g Node B) as an example of a base station and a server are connected via a user plane function (UPF). The UPF is a node which is in charge of processing user plane data in the 5G system, and may be configured with dedicated hardware apparatuses.

Further, an external network 60 such as the Internet may be connected to the core network 40. The communication control apparatus 20 may acquire information (for example, weather information, earthquake occurrence information, and the like.) leading to the identification of the bottleneck from an information provision server that is connected to the external network 60 and provides various types of information via the core network 40. As in this example, the communication control system 100 may acquire information identifying the bottleneck via the core network 40, and may give a notification to the main control entity via the core network 40.

However, a configuration in which acquisition of the information identifying the bottleneck or the notification to the main control entity are not performed via the core network 40 is possible. That is, the communication control system 100 may include other network systems that construct a network that does not go through the core network 40, for example, a network system of a WiFi (registered trademark) standard. Then, the communication control apparatus 20 may perform transmission and reception of information with other network systems.

In FIG. 4 and subsequent drawings, an example in which the mobile object 50 serving as a service provision target is the vehicle is illustrated, the description thereof will proceed under the assumption that the mobile object 50 is the vehicle, but the present disclosure is not limited thereto, and the service provision target may be other types of mobile objects. For example, a mobile communication terminal apparatus such as a smartphone carried by a passenger in the mobile object 50 may be set as a mobile object serving as a service provision target. In this case, the mobile communication terminal apparatus may be connected to the mobile object 50 in a wired or wireless manner and acquire vehicle information such as a vehicle speed in the mobile object 50 to be described later, information indicating a surrounding situation, or the like.

Prior to the description of the communication control apparatus 20, a configuration example of the information processing apparatus mounted on the mobile object 50 in an example in which the mobile object 50 is the service provision target will be described with reference to FIG. 5.

As illustrated in FIG. 5, the mobile object 50 may include a surrounding monitoring sensor 51, a vehicle sensor 52, a vehicle control electric control unit (ECU) 53, an automatic driving ECU 54, a communication apparatus 55, and a service provision apparatus 56. In the mobile object 50, these components are configured so as to be able to communicate with one another via a network such as a local area network (LAN) or a controller area network (CAN).

The surrounding monitoring sensor 51 is a sensor that monitors a situation surrounding the mobile object 50. In the following description, the surrounding monitoring sensor 51 will be described using a camera as an example, but the present invention is not limited thereto. Examples of the surrounding monitoring sensor 51 include a camera, a depth sensor, a radar, and light detection and ranging (LiDAR). The surrounding monitoring sensor 51 may, for example, include a plurality of cameras that capture images of the front, rear, right, and left sides of the vehicle. The surrounding monitoring sensor 51 may include a camera that captures an image of the inside of the mobile object 50 or may include a temperature sensor that measures an ambient temperature.

The vehicle sensor 52 is a sensor that detects various states of the mobile object 50, that is, vehicle information of the mobile object 50. The vehicle sensor 52 includes, for example, sensors such as a vehicle speed sensor that detects vehicle speed, a steering sensor that detects a steering angle, an accelerator position sensor that detects an opening degree of an accelerator pedal, and a brake effort sensor that detects a depression amount of a brake pedal, and the like. The vehicle sensor 52 or the surrounding monitoring sensor 51 may include a position information sensor that acquires position information of the mobile object 50, which can be exemplified by a satellite positioning sensor such as a global positioning system (GPS).

The vehicle control ECU 53 is an electronic control apparatus that controls driving and others of the mobile object 50. In general, the electronic control apparatus is provided with a processor, a memory, an input/output (I/O), and a bus that connects them. On the basis of sensor information output from the vehicle sensor 52, the vehicle control ECU 53 executes various controls, such as control of a fuel injection amount, control of an engine ignition timing, and control of a power steering assist amount.

The automatic driving ECU 54 is an electronic control apparatus that controls automatic driving of the mobile object 50. The automatic driving ECU 54 obtains sensor information from the surrounding monitoring sensor 51 and the vehicle sensor 52, and controls automatic driving of the mobile object 50 on the basis of the obtained sensor information.

The communication apparatus 55 is configured as an apparatus that performs wireless communication between the mobile object 50 and the base stations 42a and 42b. The communication apparatus 55 includes a wireless communication antenna, a transmitter, and a receiver as a hardware configuration. Further, the communication apparatus 55 includes a processor, a memory, an I/O, and a bus that connects these. The function of each unit in the communication apparatus 55 is implemented, for example, in such a way that a control program stored in the memory is executed by the processor.

The service provision apparatus 56 is an apparatus that receives the service from the server A 30a and provides the service to the inside of the mobile object 50 or an operator of the mobile object 50, and can be configured with an ECU, a CPU, or the like. A process of providing the service may be implemented by incorporating a service provision program into a general-purpose information processing apparatus in an executable manner. Further, the service provision apparatus 56 may be incorporated, as, for example, a service provision program or the like, into other apparatuses such as a navigation system mounted on the mobile object 50.

The service provision apparatus 56 may give, to the vehicle control ECU 53 or the automatic driving ECU 54, a notification to activate an alert in a system in the vehicle depending on a type of service, or may provide the service from a display unit, a voice output unit, or the like provided in a separately mounted navigation system or the like.

The description returns to FIG. 4. The communication control apparatus 20 includes an identification unit 22, a decision unit 23, and a notification unit 25 which are substantially equivalent to the identification unit 1a, the decision unit 1b, and the notification unit 1c, respectively, and may include a storage unit 21 and a selection unit 24. Further, although not illustrated, the main control entity serving as the notification destination of the notification unit 25 includes a control unit that receives the notification and executes control of the control method. Further, although not illustrated, the communication control apparatus 20 may include an information acquisition unit that acquires the identification target information. Further, the communication control apparatus 20 may be implemented in such a way that the functions of the respective units are distributed to separate apparatuses, and a distribution method thereof is not limited. For example, the communication control apparatus 20 may be configured with an apparatus including the storage unit 21, an apparatus including the identification unit 22, an apparatus including the decision unit 23, an apparatus including the selection unit 24, and an apparatus including the notification unit 25.

The storage unit 21 temporarily stores the identification target information which is acquired by the information acquisition unit and used by the identification unit 22. Further, the storage unit 21 may store a correspondence relationship for identifying the bottleneck on the basis of the identification target information by the identification unit 22 or a correspondence relationship between the identified bottleneck and the control method decided by the decision unit 23. Further, the storage unit 21 may store a correspondence relationship between the decided control method and the main control entity capable of executing control by the control method, and this correspondence relationship may be used by the selection unit 24 as described later.

The identification unit 22 identifies the bottleneck of the communication problem in the service provision system that provides the service from the server A 30a to the mobile object 50 on the basis of the identification target information. As described above, the factors that cause the communication problem include, for example, the traffic load in the wireless communication section, the high load or failure of the server A 30a or the mobile object 50, the wireless quality in the wireless communication section, the physical distance between the server A 30a and the mobile object 50, and the like.

The identification unit 22 may identify which one of the wireless communication section, the server A 30a, and the mobile object 50 causes the bottleneck leading to the communication problem on the basis of the identification target information. The identification unit 22 may perform more fine identification. For example, the identification unit 22 may identify, for example, whether the traffic load causes the bottleneck or the wireless quality causes the bottleneck as the bottleneck for the wireless communication section. Further, the identification unit 22 may identify, as the bottleneck for the server A 30a, whether the load on the server A 30a causes the bottleneck or whether the physical distance from the mobile object 50 causes the bottleneck. Note that the latter physical distance may be regarded as an example in which both the server A 30a and the mobile object 50 cause the bottleneck. The case in which the mobile object 50 causes the bottleneck may indicate that the load of the mobile object 50 causes the bottleneck.

Examples of the identification target information used for identifying the bottleneck include information indicating the congestion status of the network, the time required for processing related to the service in each apparatus, the priority of processing related to the service in each apparatus, and the congestion status of processing in each apparatus. Alternatively, the identification target information includes information that can be checked by analysis or the like.

Specifically, the identification target information may include the communication packet information (which may include the communication packet information between the core network 40 and the base station 42a) of the communication performed between the respective apparatuses for communication between the server A 30a and the mobile object 50. The actually measured communication packet information can be regarded as information indicating a communication traffic at the time of actual measurement. However, traffic information indicating communication traffic may be obtained by using information other than the communication packet information, and the obtained traffic information may be used as the identification target information. The traffic information is, for example, a communication amount, a delay amount, a transmission error rate, and a retransmission rate of data exchanged between the server A 30a and the mobile object 50. The communication packet information and other traffic information may be acquired from the core network 40, the server A 30a, or the mobile object 50, but an acquisition route or an acquisition method of the communication packet are not limited.

The identification target information may include surrounding information indicating a surrounding environment of the mobile object 50. Since movement of the mobile object 50 is accompanied by a relative change in the surrounding environment, the surrounding environment may include information related to movement of the mobile object 50 itself. Here, the surrounding information may be information indicating an object, an environment, or the like which is physically present around the mobile object 50, and examples thereof include information indicating a building such as a high-rise building that may cause radio wave interference, weather, temperature, earthquake occurrence information, and the like. Since the radio wave condition may change depending on the weather or the temperature, and when an earthquake occurs, the wireless communication section may be congested or a failure may occur, it is beneficial to use these pieces of information as the identification target information.

These pieces of surrounding information may be acquired from the mobile object 50 or the server A 30a as, for example, information such as position information obtained by the surrounding monitoring sensor 51 or the vehicle sensor 52 including the position information sensor. Further, these pieces of surrounding information may be acquired from other mobile objects around the mobile object 50, and camera videos (video data) captured by cameras installed at respective points may be acquired from the spot information transmission apparatus or the server A 30a. These pieces of surrounding information may be acquired from an information provision server connected to the external network 60.

However, an acquisition route or an acquisition method of the surrounding information is not limited. For example, as the surrounding information, information exchanged by vehicle-to-vehicle communication such as cellular vehicle to everything (C-V2X) communication may be acquired by a road side unit (RSU). The communication control apparatus 20 may acquire the surrounding information by receiving information from the RSU.

Of course, the surrounding information may be information acquired from one or more types of acquisition sources among the exemplified information.

Further, the surrounding information may be information acquired from a plurality of devices for one type of acquisition source. For example, the surrounding information may be acquired from a plurality of information acquisition devices installed at different installation locations, or may be acquired from a plurality of information provision servers that provide different pieces of information.

As described above, the method by which the identification unit 22 identifies the bottleneck of the communication problem is not limited, and the method of identifying the factor that causes the bottleneck even when there are a plurality of factors causing the communication problem is not limited. For example, the bottleneck may be identified by converting each factor into an index such as a common delay level and comparing the delay levels of the factors. Alternatively, each factor may be ranked in advance, and the factor indicating the highest rank among the generated factors may be identified as the bottleneck.

In a case in which the wireless communication section is the bottleneck, the decision unit 23 decides execution of predetermined wireless control as the control method. The predetermined wireless control may be any control that can eliminate the factor that becomes a bottleneck, and the content thereof is not limited.

As a specific example, in a case where the traffic load causes the bottleneck, the decision unit 23 may decide control to give an instruction to change the priority in the core network 40 from the communication control apparatus 20 to the core network 40. In a case in which the core network 40 is 5GC, the decision unit 23 may decide, for example, to give an instruction to change the priority to a network exposure function (NEF). The priority change here may be a change to increase the priority of a target communication compared to other communications in the core network system, and means an increase in a 5G QoS identifier (5QI) is increased in the case of 5GC. Even in a case in which the instruction to change the priority is given to the NEF with the NEF as an instruction destination (notification destination), for example, the 5GC may finally instruct the base station 42a to change the priority, and the base station 42a may change the priority.

In a case in which the wireless quality causes the bottleneck, it is basically difficult to eliminate the factor through the control of increasing the priority as described above, and thus the decision unit 23 decides to perform wireless control such as a radio frequency change or a cell change (base station change).

Specifically, the wireless control in a case in which the wireless quality causes the bottleneck will be described as an example, but a plurality of examples described below may be combined. The decision unit 23 can make a decision to instruct the following wireless control from the communication control apparatus to the core network 40 (for example, the NEF of the 5GC), the base station 42a, or the like. As the wireless control here, for example, in a case in which a millimeter wave is being used, control for handover to other frequencies such as 20 switching to Sub6 may be adopted. Further, as another control example, in order to prevent occurrence of retransmission of the wireless communication section, control of giving an instruction to change a modulation and coding scheme (MCS) and lower a multi-level modulation level may be adopted. Further, as another control example, various types of control such as control of concentrating a signal from the base station 42a on the mobile object 50 side by beamforming may be adopted. As still another control example, wireless control of changing the base station 42a communicating with the mobile object 50 to, for example, the base station 42b may be adopted.

In a case in which the server A 30a causes the bottleneck, the decision unit 23 decides execution of predetermined server control as the control method. The case in which the server A 30a causes the bottleneck may refer to a case in which the processing load of the server A 30a causes the bottleneck, or a case in which the physical distance from the mobile object 50 is long and the transmission delay on the network is large, leading to the bottleneck.

Although the example of the predetermined server control is given, a plurality of examples described below may be combined. For example, as the server control, control for increasing a processing priority of a target application in the server A 30a may be adopted. As another example of the server control, control for increasing a processing priority of a target provision destination (mobile object 50) may be adopted. In these two examples, for example, in which the server A 30a is operating in a virtualization environment, the processing priority may be increased by increasing calculation resources to be allocated such as a CPU and a memory. As another example of the server control, control of terminating an application with low priority or control of offloading an application with low priority to other servers in the server A 30a may be adopted.

As another example of the server control, server switching control of switching the provision source server from the server A 30a to the switching destination server such as the server B 30b may be adopted. The server switching control is control of executing the process described as the server switching process and may be applied even in a case in which the processing load of the server A 30a causes the bottleneck or in a case in which the long physical distance from the mobile object 50 causes the bottleneck.

As a specific example of the server switching control, for example, control of instructing the switching destination server to execute the target application may be adopted. Alternatively, as the server switching control, control in which the communication control apparatus 20, the server A 30a, or the switching destination server gives an instruction to move the target application to the switching destination server, and the switching destination gives an instruction to execute the target application may be adopted.

The instruction to cause the switching destination server to execute the target application may include an instruction to perform a routing change (communication route change) or a communication address change, which is given to the core network 40, in order to establish the communication route between the mobile object 50 and a new server (switching destination server). The instruction destination may be the core network 40. In the case of 5GC, the routing in the 5GC may be controlled via the NEF. With this routing control, settings can be performed in such a way that the communication packet flows to a different server even with the same IP address (routing is changed to cause the communication packet to flow to a desired server). As a result, the mobile object 50 can enjoy the service, which has been received from the server A 30a through communication of a path indicated by a solid line in FIG. 4, from the server B 30b through communication of a path indicated by a broken line in FIG. 4.

Further, as the switching destination server, for example, a server having a low processing load and a short physical distance may be selected as a server having a high possibility of satisfying the allowable delay in consideration of the processing load of the server to be controlled by the communication control apparatus 20 and the physical distance from the mobile object 50. However, the method of selecting the switching destination server is not limited thereto, and for example, the server serving as the switching destination may be decided in advance when the server switching control is performed on the switching source server.

In a case in which the mobile object 50 causes the bottleneck, the decision unit 23 decides execution of predetermined mobile object control (terminal control) as the control method.

Although the example of the predetermined mobile object control is given, a plurality of examples described below may be combined. For example, as the mobile object control, control of increasing the processing priority of the target application in the mobile object 50 may be adopted. For example, in a case in which the mobile object 50 operates in the virtualization environment, the processing priority may be increased by increasing the calculation resources to be allocated such as the CPU and the memory. As another example of the mobile object control, control of terminating an application with low priority in the mobile object 50 may be adopted.

As another example of the mobile object control, server switching control of switching the provision source server from the server A 30a to the switching destination server such as the server B 30b may be adopted. This server switching control is control of executing the process described as the server switching process.

The notification unit 25 gives a notification to the main control entity that executes the control method decided by the decision unit 23 as the main entity. The notification destination (main control entity) is similar to that described in the example of the control method. Here, only an example of the main control entity in a case in which the processing load of the server causes the bottleneck will be supplementarily described.

The main control entity in this case may be the server A 30a, and the server A 30a, which is operating an application which the control method has been notified of, may determine and execute the control method as an autonomous distributed apparatus in such a way that optimal control is achieved. Alternatively, for example, in a case in which control outside the authority of the server A 30a is necessary, that is, in a case in which it is difficult to solve only by the server A 30a, the upper server 31 or the management server 32 may function as the main control entity. At this time, the server 31 or the management server 32 that has been notified of the control method may make determination from an overall optimum viewpoint so that control becomes optimum as the whole system including the plurality of servers managed by the own apparatus and execute the control method.

In the determination in any example, the main control entity that has been notified of the control method may make the determination so that the processing loads of the server A 30a, the server B 30b, the server 31, and the like can be distributed. Since the management server 32 can have a function of collecting information such as the processing loads of all the target servers in order to control the server such as the server A 30a that can be a service provision source, it is possible to make determination so that is becomes optimum as a whole. For example, the management server 32 may adjust the load distribution between the server A 30a and the server B 30b when the processing load of the server A 30a causes a problem, and adjust the load distribution between the server 31 and the server of the same layer when the processing load of the server 31 causes a problem.

An example of a more specific main control entity for the 5GC will be described. By using a RAN Intelligent Controller (RIC) of an Open-Radio Access Network (O-RAN) mechanism, the notification destination serving as the main control entity may be decided as a gNB which is an example of the base station 42a. In this case, the MEC server, which is an example of the server A 30a, may cooperate with a near real time (RT) RIC or a non-RT RIC specified in the O-RAN, and directly instruct the gNB to perform control in such a way that the gNB is regulated by the control method. Further, for example, in a case in which the gNB is a base station supporting the mechanism of the near RT RIC, the MEC server may be decided as the notification destination. In this case, the MEC server that has received the notification may perform the wireless control specified by the control method in cooperation with the near RT RIC.

Further, since there may be a plurality of main control entities (the candidates of the notification destination) capable of executing the decided control method, the notification unit 25 notifies the main control entity (notification destination) that actually executes as the main entity of the control method. The candidates of the notification destination may include, for example, the core network 40, the mobile object 50, the server A 30a, the switching destination server, the management node such as a management server that manages the server A 30a or the switching destination server, or the upper server. Further, the candidates of the notification destination may include an apparatus itself (other parts of the apparatus) provided with the notification unit 25.

The process of selecting the notification destination from the candidates of the notification destination may be performed by the selection unit 24. In the configuration example described with reference to FIGS. 1 to 3, the notification unit 1c has been described to decide the notification destination, whereas in the configuration example described here, the communication control apparatus 20 includes the selection unit 24, and the selection unit 24 selects the notification destination, that is, the selection unit 24 decides the notification destination. Further, the selection unit 24 may be incorporated as part of the notification unit 25. Alternatively, in a case in which a configuration that the decision unit 23 decides not only the control method but also the notification destination is adopted, the selection unit 24 may be incorporated as part of the decision unit 23.

The selection unit 24 selects the notification destination from among the executable main control entities in accordance with a correspondence relationship between the control method decided by the decision unit 23 and the main control entity capable of executing control by the control method. This correspondence relationship may be stored in advance in the storage unit 21 as described above. Basically, the selection unit 24 may select, as the notification destination, one main control entity capable of resolving the factor that becomes the bottleneck from among the executable main control entities in accordance with the correspondence relationship.

Further, the selection unit 24 may select the notification destination on the basis of the correspondence relationship and at least one of a time required for control by the control method, an influence range exerted by the control by the control method, and a service quality required for the service being provided. For example, the selection unit 24 may perform determination as to whether cancellation is possible on the basis of the correspondence relationship and at least one of the time required for control, the influence range of control, and the service quality, and decide the notification destination in such a way that one main control entity capable of solving the factor is decided as the notification destination. The time required for the control is a time required until the bottleneck can be eliminated.

Examples of the influence range include the degree of load applied to the switching destination server in a case in which the server switching control is decided as the control method. Since it is important to maintain the required service quality in the provided service, it is beneficial to optimize the entire system in consideration of the service quality in addition to the load of the apparatus such as processing depending on resources. Therefore, it can be said that it is beneficial to refer to the quality of service of the target service. For example, in a case in which a service is being provided by an important application or an application with a high priority, the service can be executed by a server with a marginal processing load while considering the service quality from the viewpoint of overall optimization. In this case, for example, the management server 32 or the like that can give an instruction to perform switching to a server with a marginal load may be selected as the notification destination.

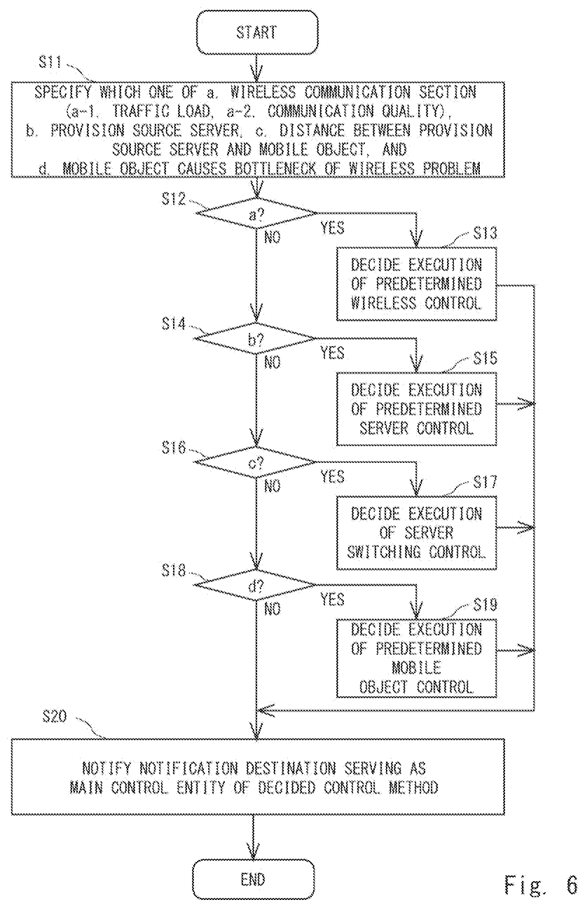

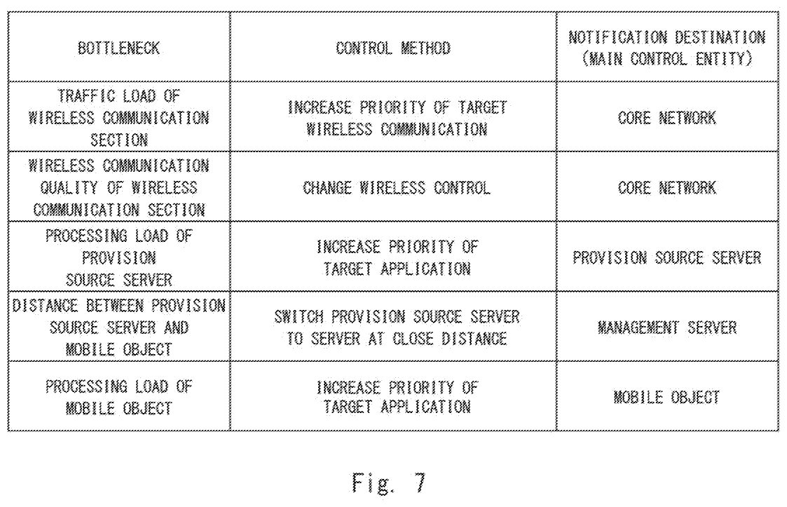

Next, a flow of a process in the communication system 100 of FIG. 4 will be described with reference to FIGS. 6 and 7. FIG. 6 is a flowchart for describing a process example in the communication control system 100 of FIG. 4, and FIG. 7 is a diagram illustrating an example of a correspondence relationship table used in the process example of FIG. 6 and is an example of information indicating a correspondence relationship stored in the storage unit 21. Further, the flow described below is merely an example, and various examples described above can be applied.

First, the identification unit 22 identifies the bottleneck of the communication problem on the basis of the identification target information which is acquired and temporarily stored in the storage unit 21 (step S11). In step S11, it is identified which one of the wireless communication section (a), the processing load of the provision source server (b: excluding (c)), the distance (c) between the provision source server and the mobile object, and the processing load (d) of the mobile object has the bottleneck. For “a”, it is also identified whether there is a bottleneck in the traffic load (a-1) of the wireless communication section or there is a bottleneck in the communication quality (a-2) of the wireless communication section.

Upon receiving the identification result of the identification unit 22, the decision unit 23 decides whether there is a bottleneck for each of “a” to “d” (steps S12, S14, S16, and S18).

In a case in which YES is determined in step S12, execution of predetermined wireless control is decided with reference to the correspondence table of FIG. 7 (step S13), and is notified of to the notification destination serving as the main control entity (step S20). In step S13, the decision unit 23 decides predetermined wireless control from the identification result indicating one of “a-1” and “a-2” that causes the bottleneck with reference to the correspondence table of FIG. 7. In a case in which the traffic load causes the bottleneck, a decision is made to execute control of increasing the priority of the target wireless communication, and in a case in which the wireless communication quality causes the bottleneck, a decision is made to execute control of changing the wireless control such as frequency change control. Then, even in any case, in step S20, the notification unit 25 decides the core network 40 as the notification destination serving as the main control entity with reference to the correspondence table of FIG. 7.

In a case in which YES is determined in step S14, execution of predetermined server control is decided with reference to the correspondence table of FIG. 7 (step S15), and is notified of to the notification destination serving as the main control entity (step S20). In step S15, the decision unit 23 decides the server control of increasing the priority of the target application from the identification result indicating that the processing load of the provision source server (the server A 30a in this example) causes the bottleneck with reference to the correspondence table of FIG. 7. In this case, in step S20, the notification unit 25 decides the server A 30a as the notification destination serving as the main control entity with reference to the correspondence table of FIG. 7.

In a case in which YES is determined in step S16, execution of predetermined server switching control is decided with reference to the correspondence table of FIG. 7 (step S17), and is notified of to the notification destination serving as the main control entity (step S20). In step S17, the decision unit 23 refers to the correspondence table of FIG. 7 from the identification result indicating that the physical distance between the provision source server (the server A 30a in this example) and the mobile object 50 causes the bottleneck. Then, the decision unit 23 decides the server switching control of switching the provision source server to the server (for example, the server B 30b) whose physical distance is close to the mobile object 50. In this case, in step S20, the notification unit 25 decides the management server 32, which manages the server capable of providing the service such as the server A 30a, as the notification destination serving as the main control entity with reference to the correspondence table of FIG. 7.

In a case in which YES is determined in step S18, execution of predetermined mobile object control is decided with reference to the correspondence table of FIG. 7 (step S19), and is notified of to the notification destination serving as the main control entity (step S20). In step S19, the decision unit 23 decides the mobile object control of increasing the priority of the target application in the mobile object 50 from the identification result indicating that the processing load of the mobile object 50 causes the bottleneck with reference to the correspondence table of FIG. 7. In this case, in step S20, the notification unit 25 decides the mobile object 50 as the notification destination serving as the main control entity with reference to the correspondence table of FIG. 7.

In a case in which step S20 is executed via any process of steps S12, S14, S16, and S18, and the notification destination is decided in step S20, the communication control apparatus 20 notifies the notification destination of the control method. Then, the control method is executed in the notification destination, and the cause of the bottleneck is eliminated. Note that the order of the process of steps S12 and S13, the process of steps S14 and S15, the process of steps S16 and S17, and the process of steps S18 and S19 is not limited.

Further, the process of steps S11 to S20 may be executed on the basis of a predetermined criterion, such as execution at predetermined intervals, as illustrated for the process of FIG. 3. Further, the process of steps S11 to S20 may be executed as one set until there is no factor that can be regarded as a bottleneck, and accordingly, it is possible to solve large communication problems in order.

Further, in order to simplify the description, the example in which the control method and the main control entity have a one-to-one correspondence relationship in the correspondence table of FIG. 7 has been described, but a plurality of candidates that can serve as the main control entity may be described for a single control method. In this case, the selection unit 24 may select the notification destination on the basis of at least one of a time required for control by the control method, an influence range exerted by the control by the control method, and a service quality required for the service being provided.

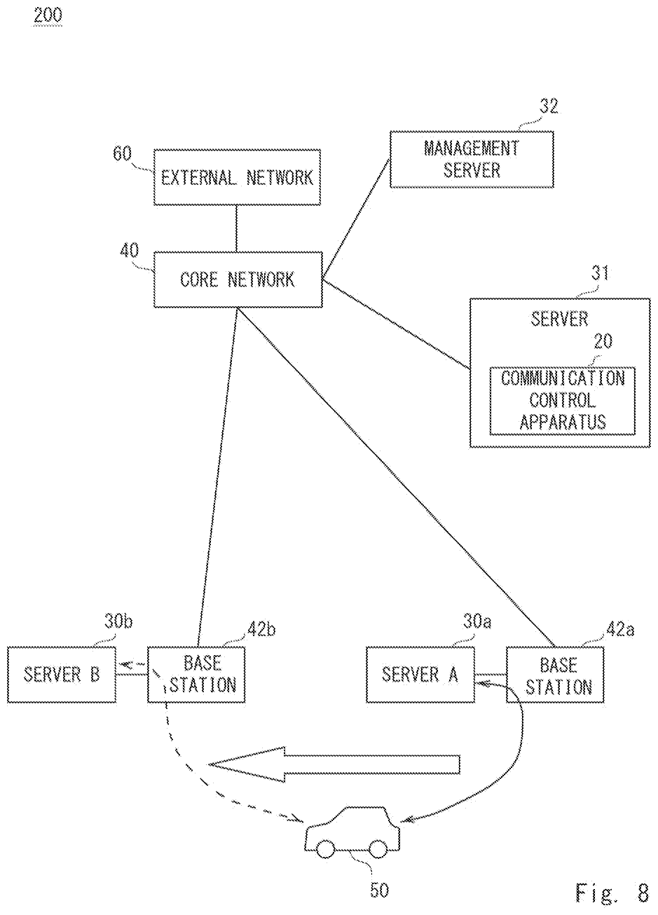

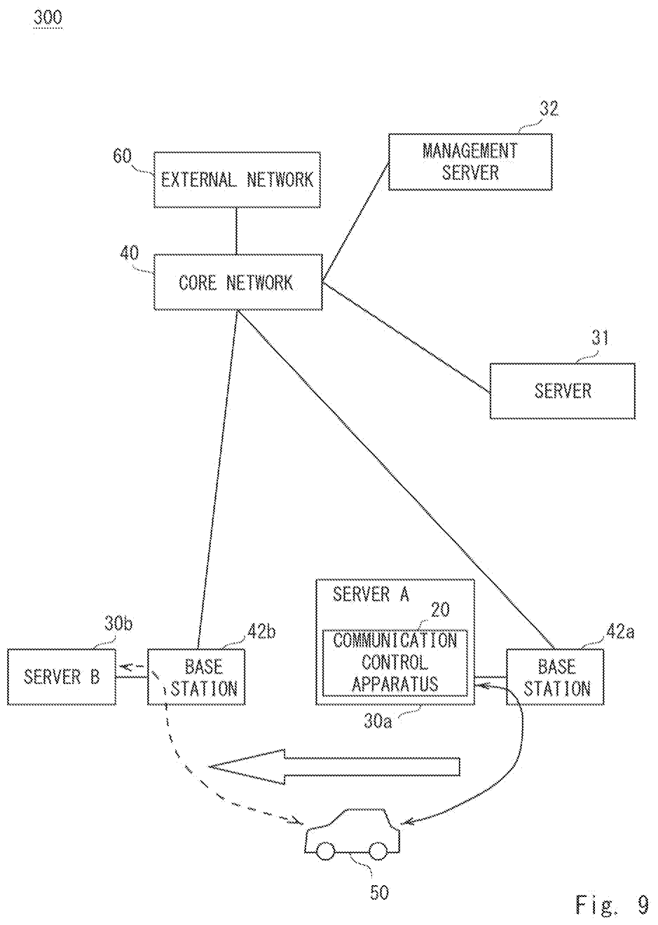

Further, the communication control apparatus 20 in the communication control system 100 of FIG. 4 may be incorporated into the server 31 as in the communication control system 200 illustrated in FIG. 8, or may be incorporated into the server A 30a as in the communication control system 300 illustrated in FIG. 9. FIGS. 8 and 9 are block diagrams illustrating still another configuration example of the communication control system 1 of FIG. 1. Note that the communication control apparatus 20 may be incorporated into the server B 30b. Of course, the communication control apparatus 20 can be incorporated into a plurality of servers.

in the communication control system 200 illustrated in FIG. 8, the communication control system 300 illustrated in FIG. 9, and the communication control system 100 illustrated in FIG. 4, the notification destination changes depending on the bottleneck to be identified. Therefore, depending on the system configuration of the communication control system to be constructed, it is desirable to set the notification destination in accordance with the system configuration. Further, the communication control systems 100, 200, and 300 may change the decided control method depending on the identified bottleneck with one another. Therefore, similarly to the notification destination, depending on the system configuration of the communication control system to be constructed, it is desirable to set the control method to be decided in accordance with the system configuration.

As described above, the communication control system or the communication control apparatus according to the present example embodiment can be used to cope with the bottleneck of the communication problem, for example, in the service provision system in which the base station and the server serving as the service provision source are arranged at each intersection and the service is provided to the mobile object. Therefore, according to the present example embodiment, it is possible to give a notification for coping with the factor that causes the bottleneck of the communication problem in the service provision system. For example, as described with reference to FIGS. 4 to 8, in the present example embodiment, it is possible to subdivide and analyze the communication problem such as the occurrence of the delay, identify the bottleneck, and execute the appropriate control for resolving the bottleneck.

### Second Example Embodiment

A second example embodiment will be described with reference to the configuration example of FIG. 4, focusing on differences from the operation in the configuration example of FIG. 4 in the first example embodiment, but various examples described in the first example embodiment can be applied in the present example embodiment.

In a case in which the server A 30a is selected as an executable main control entity in accordance with the correspondence relationship such as the correspondence table of FIG. 7, for example, the selection unit 24 according to the present example embodiment determines whether or not the factor that becomes the bottleneck can be resolved. Note that this determination may also be, for example, determination as to whether it can be resolved within a predetermined time. Either a method of predicting in advance without performing control by the decided control method or a method of determining as a result of actually performing control by the decided control method may be adopted as this determination.

Then, in a case in which it is determined that it is difficult to eliminate the factor, the selection unit 24 selects (selects as the main control entity) one notification destination from the management node such as the management server 32 that manages the server A 30a and a plurality of other servers. In order to enable this selection, it is desirable that can be executed by the server A 30a, the management node, and a plurality of other servers are described in the correspondence relationship as executable main control entities in association with the factor. Note that, in a case in which the factor is a factor that can be solved only by the server A 30a, for example, the server A 30a may be notified of again as the notification destination, and retry may be performed by the server A 30a.

Here, a plurality of other servers refers to servers that are different from the server A 30a and can provide the services, and may refer to, for example, the server B 30b and the server 31 in the example of FIG. 4. As described above, in the present example embodiment, even if the apparatus that has performed the identification of the bottleneck is the server A 30a, the other apparatuses are notified of the control method.

For example, when it is determined that the factor is hardly resolved by the server A 30a, the selection unit 24 may select one notification destination from the management node and a plurality of other servers on the basis of the time required for control by the control method (that is, the response time for resolving the bottleneck). In this example, in a case in which the factor is hardly resolved by the server A 30a, the main control entity that executes the control method decided by the decision unit 23 may be changed on the basis of the response time.

Alternatively, when it is determined that the factor is hardly resolved by the server A 30a, the selection unit 24 may select one notification destination from among the management node and a plurality of other servers on the basis of the loads of the plurality of other servers (for example, the server B 30b and the server 31). This is because the time required for handling changes depending on the loads of a plurality of other servers. In this example, in a case in which the factor is hardly resolved by the server A 30a, the main control entity that executes the control method decided by the decision unit 23 may be changed on the basis of the loads of a plurality of other servers. In this example, since the information on the loads of a plurality of other servers can be monitored by the management server 32 in the configuration example of FIG. 4, it is desirable in terms of the system configuration that the management server 32 having the information on the loads is selected as the notification destination. However, also in this example, the server B 30b and the server 31 may be selected as the notification destinations.

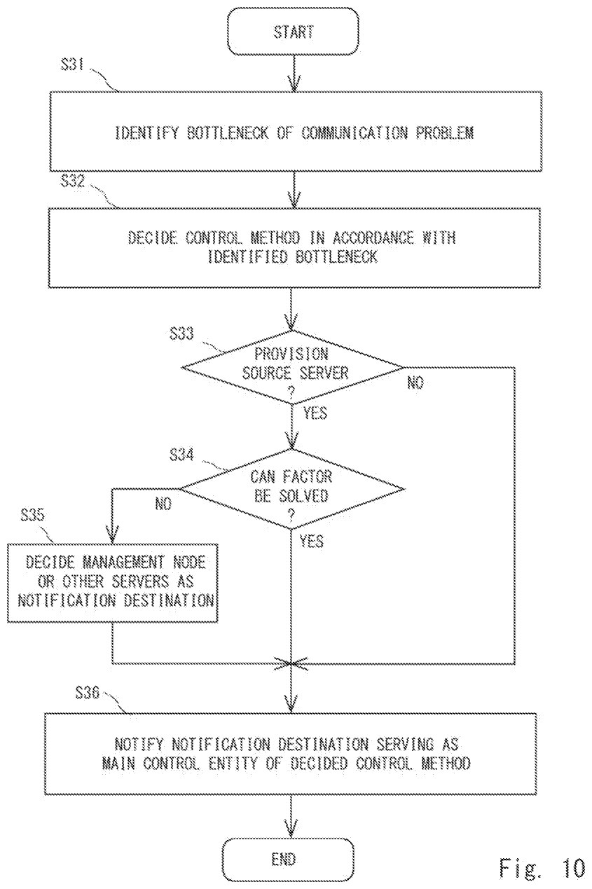

A process example of this communication control method will be described with reference to FIG. 10. FIG. 10 is a flowchart for describing an example of the communication control method in the communication control system according to the present example embodiment.

In this communication control method, first, the identification unit 22 executes an identification process of identifying the bottleneck of the communication problem in the service provision system that provides the service from the provision source server to the mobile object (step S31). Next, the decision unit 23 executes a decision process of deciding the control method in accordance with the bottleneck identified in the identification process (step S32). For example, the process of steps S12 to S19 of FIG. 6 may be applied to the process of step S32.

After step S32, the selection unit 24 determines whether the provision source server (the server A 30a in this example) is selected as the main control entity that executes the control method decided in the decision process from, for example, the correspondence table of FIG. 7 (step S33).

Further, the example in which the control method and the main control entity have a one-to-one correspondence relationship in the correspondence table of FIG. 7 has been described, but a plurality of candidates that can serve as the main control entity may be described for a single control method. In this case, the selection unit 24 may select the notification destination on the basis of at least one of a time required for control by the control method, an influence range exerted by the control by the control method, and a service quality required for the service being provided. In step S33, it is also possible to determine whether or not the notification destination selected as described above is the provision source server. Alternatively, in a case in which a plurality of candidates that can serve as the main control entity are described for one control method, in step S33, the selection unit 24 may determine whether or not the provision source server is included among the candidates.

In a case in which NO is determined in step S33, the notification unit 25 executes the notification process of notifying the notification destination (in this case, the server A 30a) serving as the main control entity of the control method decided in the decision process (step S36).

In a case in which YES is determined in step S33, the selection unit 24 determines whether or not the factor that has caused the bottleneck in the provision source server can be resolved (step S34). In a case in which YES is determined in step S34, the notification unit 25 executes the notification process of notifying the notification destination (in this case, the server A 30a) serving as the main control entity of the control method decided in the decision process (step S36).

On the other hand, in a case in which NO is determined in step S34, the selection unit 34 decides the management node or other servers as the notification destination (step S35), and the notification unit 25 executes the notification process of notifying the notification destination serving as the main control entity of the control method decided in the decision process (step S36). The decision of step S35 may be performed on the basis of a predetermined criterion. For example, the selection unit 24 may decide the notification destination from the management node or other servers on the basis of at least one of the time required for the control by the control method, the influence range exerted by the control by the control method, and the quality of service required for the service being provided.

Then, on the basis of the notification of step S36, the main control entity that has received the notification executes the control method decided in the decision process to solve the communication problem that causes the bottleneck. Information indicating a type of control to be executed may be included in the notification, or a type of control to be executed may be decided in advance at a time point at which the notification is given in the notification destination.

Further, the process of steps S31 to S36 may be executed on the basis of a predetermined criterion, such as execution at predetermined intervals, as illustrated for the process of FIG. 3. Further, the process of steps S31 to S36 may be executed as one set until there is no factor that can be regarded as a bottleneck, and accordingly, it is possible to solve large communication problems in order.

As described above, in the present example embodiment, in addition to the effects of the first example embodiment, even in a case in which the provision source server hardly solves the factor that becomes the bottleneck, it is possible to cause other apparatuses to solve the factor.

Further, a similar idea may be applied to a case in which the control method is the server switching process or a case in which the switching destination server (for example, the server B 30b) is selected as the main control entity. Specifically, in the description of FIG. 10, in step S33, it is determined whether or not it is the switching destination server, and in step S34, it is determined whether or not the factor can be resolved in the switching destination server. Then, in step S35, the management node or other servers (the servers that are not the switching destination server) is decided as the notification destination. With this process, even when the factor that causes the bottleneck is hardly eliminated by the switching destination server, it is possible to cause other apparatuses to eliminate the factor.

### Others

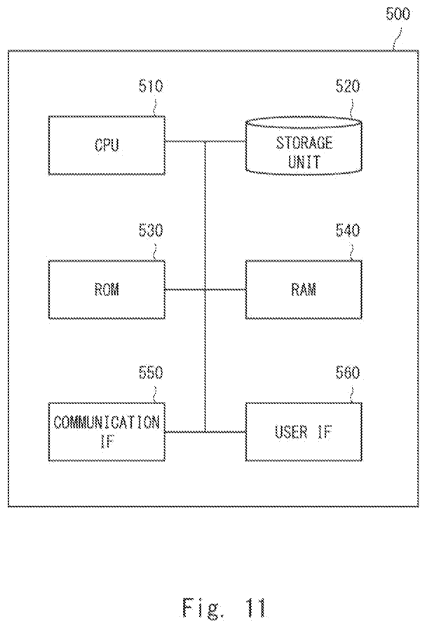

In the present disclosure, the apparatuses such as the communication control apparatus, the server, and the mobile communication terminal apparatus may be configured as a computer apparatus. FIG. 11 is a block diagram illustrating an example of a configuration of a computer apparatus. A computer apparatus 500 includes, as a control unit, a central processing unit (CPU) 510, a storage unit 520, a read only memory (ROM) 530, and a random access memory (RAM) 540. Further, the computer apparatus 500 may include a communication interface (IF) 550 and a user interface 560.

Further, the computer apparatus 500 may be used as any of the communication control apparatuses 2 and 20. Furthermore, the computer apparatus 500 may be used as any one of a server (for example, the server A 30a and the server B 30b) that provides the services, the server 31, and the management server 32. Further, the computer apparatus 500 may be used as an information processing apparatus mounted on the mobile object 50, and may be used as the mobile communication terminal apparatus brought into the mobile object 50.

The communication interface 550 is an interface for connecting the computer apparatus 500 to a communication network through wired communication means, wireless communication means, or the like. The user interface 560 may include, for example, a display unit such as a display. Further, the user interface 560 may include input units such as a keyboard, a mouse, and a touch panel.

The storage unit 520 is an auxiliary storage device that can hold various types of data. The storage unit 520 need not to be necessarily part of the computer apparatus 500 and may be an external storage device or a cloud storage connected to the computer apparatus 500 via a network.

The ROM 530 is a non-volatile storage device. For example, a semiconductor storage device such as a flash memory having a relatively small capacity may be used for the ROM 530. A program that is executed by the CPU 510 may be stored in the storage unit 520 or the ROM 530. The storage unit 520 or the ROM 530 stores various programs for implementing the functions of the respective units in the computer apparatus 500.

The program includes a group of instructions (or software codes) for causing a computer to perform one or more functions that have been described in the example embodiments when the program is read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a compact disc (CD), a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communication medium. As an example and not by way of limitation, the transitory computer-readable medium or the communication medium includes propagated signals in electrical, optical, acoustic, or any other form.

The RAM 540 is a volatile storage device. As the RAM 540, various types of semiconductor memory devices such as a dynamic random access memory (DRAM) or a static random access memory (SRAM) may be used. The RAM 540 may be used as an internal buffer for temporarily storing data or the like. The CPU 510 develops a program, stored in the storage unit 520 or the ROM 530, in the RAM 540, and executes the developed program. The functions of the respective units in the computer apparatus 500 may be implemented by the CPU 510 executing the program. The CPU 510 may include an internal buffer in which data or the like can be temporarily stored.

Although example embodiments according to the present disclosure have been described above in detail, the present disclosure is not limited to the above-described example embodiments, and the present disclosure also includes those that are obtained by making changes or modifications to the above-described example embodiments without departing from the spirit of the present disclosure.

For example, some or all of the above-described example embodiments may be described as the following supplementary notes, but the present disclosure is not limited to the following supplementary notes.

### Supplementary Note 1

A communication control system, including:
an identification means for identifying a bottleneck of a communication problem in a service provision system that provides a service from a provision source server to a mobile object:
a decision means for deciding a control method in accordance with the bottleneck identified by the identification means: and
a notification means for notifying a notification destination as a main control entity that executes control by the control method of the control method decided by the decision means.

### Supplementary Note 2

The communication control system according to supplementary note 1, further including, a selection means for selecting the notification destination from among main control entities capable of executing control by the control method in accordance with a correspondence relationship between the control method decided by the decision means and the main control entities capable of executing the control.

### Supplementary Note 3

The communication control system according to supplementary note 2, wherein the selection means selects the notification destination on the basis of the correspondence relationship and at least one of a time required for the control by the control method, an influence range exerted by the control by the control method, and a service quality required for the service.

### Supplementary Note 4

The communication control system according to supplementary note 2 or 3, wherein the selection means selects, as the notification destination, a main control entity capable of eliminating a factor that causes the bottleneck from among the main control entities capable of executable in accordance with the correspondence relationship.

### Supplementary Note 5

The communication control system according to supplementary note 2 or 3, wherein the selection means determines whether or not a factor that causes the bottleneck can be eliminated in a case in which the provision source server is selected as the main control entity capable of executing in accordance with the correspondence relationship, and selects one notification destination from a management node that manages the provision source server and a plurality of other servers which are different from the provision source server and capable of providing the service in a case in which it is determined that the factor can not be eliminated.

### Supplementary Note 6

The communication control system according to any one of supplementary notes 1 to 5, wherein
the identification means identifies which one of a wireless communication section, the provision source server, and the mobile object causes the bottleneck and incurs the communication problem, and
the decision means
decides execution of predetermined wireless control as the control method in a case in which the wireless communication section causes the bottleneck,
decides execution of predetermined server control as the control method in a case in which the provision source server causes the bottleneck, and
decides execution of predetermined mobile object control as the control method in a case in which the mobile object causes the bottleneck.

### Supplementary Note 7

A communication control apparatus, including:
an identification means for identifying a bottleneck of a communication problem in a service provision system that provides a service from a provision source server to a mobile object:
a decision means for deciding a control method in accordance with the bottleneck identified by the identification means; and
a notification means for notifying a notification destination as a main control entity that executes control by the control method of the control method decided by the decision means.

### Supplementary Note 8

The communication control apparatus according to supplementary note 7, further including, a selection means for selecting the notification destination from among main control entities capable of executing control by the control method in accordance with a correspondence relationship between the control method decided by the decision means and the main control entities capable of executing the control.

### Supplementary Note 9

The communication control apparatus according to supplementary note 8, wherein the selection means selects the notification destination on the basis of the correspondence relationship and at least one of a time required for the control by the control method, an influence range exerted by the control by the control method, and a service quality required for the service.

### Supplementary Note 10

The communication control apparatus according to supplementary note 8 or 9, wherein the selection means selects, as the notification destination, a main control entity capable of eliminating a factor that causes the bottleneck from among the main control entities capable of executable in accordance with the correspondence relationship.

### Supplementary Note 11

The communication control apparatus according to supplementary note 8 or 9, wherein the selection means determines whether or not a factor that causes the bottleneck can be eliminated in a case in which the provision source server is selected as the main control entity capable of executing in accordance with the correspondence relationship, and selects one notification destination from a management node that manages the provision source server and a plurality of other servers which are different from the provision source server and capable of providing the service in a case in which it is determined that the factor can not be eliminated.

### Supplementary Note 12

The communication control apparatus according to any one of supplementary notes 7 to 11, wherein
the identification means identifies which one of a wireless communication section, the provision source server, and the mobile object causes the bottleneck and incurs the communication problem, and
the decision means
decides execution of predetermined wireless control as the control method in a case in which the wireless communication section causes the bottleneck,
decides execution of predetermined server control as the control method in a case in which the provision source server causes the bottleneck, and
decides execution of predetermined mobile object control as the control method in a case in which the mobile object causes the bottleneck.

### Supplementary Note 13

A communication control method, including:

executing an identification process of identifying a bottleneck of a communication problem in a service provision method of providing a service from a provision source server to a mobile object:
executing a decision process of deciding a control method in accordance with the bottleneck identified by the identification process: and
executing a notification process of notifying a notification destination as a main control entity that executes control by the control method of the control method decided by the decision process.

### Supplementary Note 14

The communication control method according to supplementary note 13, further including, a selection process of selecting the notification destination from among main control entities capable of executing control by the control method in accordance with a correspondence relationship between the control method decided by the decision process and the main control entities capable of executing the control.

### Supplementary Note 15

The communication control method according to supplementary note 14, wherein the selection process includes selecting the notification destination on the basis of the correspondence relationship and at least one of a time required for the control by the control method, an influence range exerted by the control by the control method, and a service quality required for the service.

### Supplementary Note 16

The communication control method according to supplementary note 14 or 15, wherein the selection process includes selecting, as the notification destination, a main control entity capable of eliminating a factor that causes the bottleneck from among the main control entities capable of executable in accordance with the correspondence relationship.

### Supplementary Note 17

The communication control method according to supplementary note 14 or 15, wherein the selection process includes determining whether or not a factor that causes the bottleneck can be eliminated in a case in which the provision source server is selected as the main control entity capable of executing in accordance with the correspondence relationship, and selecting one notification destination from a management node that manages the provision source server and a plurality of other servers which are different from the provision source server and capable of providing the service in a case in which it is determined that the factor can not be eliminated.

### Supplementary Note 18

The communication control method according to any one of supplementary notes 13 to 17, wherein
the identification process includes identifying which one of a wireless communication section, the provision source server, and the mobile object causes the bottleneck and incurs the communication problem, and
the decision process includes
deciding execution of predetermined wireless control as the control method in a case in which the wireless communication section causes the bottleneck,
deciding execution of predetermined server control as the control method in a case in which the provision source server causes the bottleneck, and
deciding execution of predetermined mobile object control as the control method in a case in which the mobile object causes the bottleneck.

### Supplementary Note 19

A program causing a computer to execute:
an identification process of identifying a bottleneck of a communication problem in a service provision method of providing a service from a provision source server to a mobile object:
a decision process of deciding a control method in accordance with the bottleneck identified by the identification process; and
a notification process of notifying a notification destination as a main control entity that executes control by the control method of the control method decided by the decision process.

### Supplementary Note 20

The program according to supplementary note 19, further including, a selection process of selecting the notification destination from among main control entities capable of executing control by the control method in accordance with a correspondence relationship between the control method decided by the decision process and the main control entities capable of executing the control.

### Supplementary Note 21

The program according to supplementary note 20, wherein the selection process includes selecting the notification destination on the basis of the correspondence relationship and at least one of a time required for the control by the control method, an influence range exerted by the control by the control method, and a service quality required for the service.

### Supplementary Note 22

The program according to supplementary note 20 or 21, wherein the selection process includes selecting, as the notification destination, a main control entity capable of eliminating a factor that causes the bottleneck from among the main control entities capable of executable in accordance with the correspondence relationship.

### Supplementary Note 23

The program according to supplementary note 20 or 21, wherein the selection process includes determining whether or not a factor that causes the bottleneck can be eliminated in a case in which the provision source server is selected as the main control entity capable of executing in accordance with the correspondence relationship, and selecting one notification destination from a management node that manages the provision source server and a plurality of other servers which are different from the provision source server and capable of providing the service in a case in which it is determined that the factor can not be eliminated.

### Supplementary Note 24

The program according to any one of supplementary notes 19 to 23, wherein
the identification process includes identifying which one of a wireless communication section, the provision source server, and the mobile object causes the bottleneck and incurs the communication problem, and
the decision process includes
deciding execution of predetermined wireless control as the control method in a case in which the wireless communication section causes the bottleneck,
deciding execution of predetermined server control as the control method in a case in which the provision source server causes the bottleneck, and
deciding execution of predetermined mobile object control as the control method in a case in which the mobile object causes the bottleneck.

### REFERENCE SIGNS LIST

1, 100, 200, 300 COMMUNICATION CONTROL SYSTEM
1a, 22 IDENTIFICATION UNIT
1b, 23 DECISION UNIT
1c, 25 NOTIFICATION UNIT
2, 20 COMMUNICATION CONTROL APPARATUS
21 STORAGE UNIT
24 SELECTION UNIT
30a SERVER A
30b SERVER B
31 SERVER
32 MANAGEMENT SERVER
40 CORE NETWORK
42a, 42b BASE STATION
51 SURROUNDING MONITORING SENSOR
52 VEHICLE SENSOR
53 VEHICLE CONTROL ECU
54 AUTOMATIC DRIVING ECU
55 COMMUNICATION APPARATUS
56 SERVICE PROVISION APPARATUS
50 MOBILE OBJECT
60 EXTERNAL NETWORK
500 COMPUTER APPARATUS
510 CPU
520 STORAGE UNIT
530 ROM
540 RAM
550 COMMUNICATION INTERFACE
560 USER INTERFACE

what is claimed is:

1. A communication control system, comprising:
at least one memory storing instructions; and
at least one processor configured to execute the instructions to do communication controlling, the communication controlling includes:
identifying a bottleneck of a communication problem in a service provision system that provides a service from a provision source server to a mobile object;
deciding a control method in accordance with the bottleneck identified by the identifying; and
notifying a notification destination as a main control entity that executes control by the control method of the control method decided by the deciding.

2. The communication control system according to claim 1, wherein the communication controlling further includes selecting the notification destination from among main control entities capable of executing control by the control method in accordance with a correspondence relationship between the control method decided by the deciding and the main control entities capable of executing the control.

3. The communication control system according to claim 2, wherein the selecting is selecting the notification destination on the basis of the correspondence relationship and at least one of a time required for the control by the control method, an influence range exerted by the control by the control method, and a service quality required for the service.

4. The communication control system according to claim 2, wherein the selecting is selecting, as the notification destination, a main control entity capable of eliminating a factor that causes the bottleneck from among the main control entities capable of executable in accordance with the correspondence relationship.

5. The communication control system according to claim 2, wherein the selecting includes determining whether or not a factor that causes the bottleneck can be eliminated in a case in which the provision source server is selected as the main control entity capable of executing in accordance with the correspondence relationship, and selecting one notification destination from a management node that manages the provision source server and a plurality of other servers which are different from the provision source server and capable of providing the service in a case in which it is determined that the factor can not be eliminated.

6. The communication control system according to claim 1, wherein
the identifying is identifying which one of a wireless communication section, the provision source server, and the mobile object causes the bottleneck and incurs the communication problem, and
the deciding includes
deciding execution of predetermined wireless control as the control method in a case in which the wireless communication section causes the bottleneck,
deciding execution of predetermined server control as the control method in a case in which the provision source server causes the bottleneck, and
deciding execution of predetermined mobile object control as the control method in a case in which the mobile object causes the bottleneck.

7. A communication control apparatus, comprising:
at least one memory storing instructions; and
at least one processor configured to execute the instructions to do communication controlling, the communication controlling includes:
identifying a bottleneck of a communication problem in a service provision system that provides a service from a provision source server to a mobile object;
deciding a control method in accordance with the bottleneck identified by the identifying; and
notifying a notification destination as a main control entity that executes control by the control method of the control method decided by the deciding.

8. The communication control apparatus according to claim 7, wherein the communication controlling further includes selecting the notification destination from among main control entities capable of executing control by the control method in accordance with a correspondence relationship between the control method decided by the deciding and the main control entities capable of executing the control.

9. The communication control apparatus according to claim 8, wherein the selecting is selecting the notification destination on the basis of the correspondence relationship and at least one of a time required for the control by the control method, an influence range exerted by the control by the control method, and a service quality required for the service.

10. The communication control apparatus according to claim 8, wherein the selecting is selecting, as the notification destination, a main control entity capable of eliminating a factor that causes the bottleneck from among the main control entities capable of executable in accordance with the correspondence relationship.

11. The communication control apparatus according to claim 8, wherein the selecting includes determining whether or not a factor that causes the bottleneck can be eliminated in a case in which the provision source server is selected as the main control entity capable of executing in accordance with the correspondence relationship, and selecting one notification destination from a management node that manages the provision source server and a plurality of other servers which are different from the provision source server and capable of providing the service in a case in which it is determined that the factor can not be eliminated.

12. The communication control apparatus according to claim 7, wherein
the identifying is identifying which one of a wireless communication section, the provision source server, and the mobile object causes the bottleneck and incurs the communication problem, and
the deciding includes
deciding execution of predetermined wireless control as the control method in a case in which the wireless communication section causes the bottleneck,
deciding execution of predetermined server control as the control method in a case in which the provision source server causes the bottleneck, and
deciding execution of predetermined mobile object control as the control method in a case in which the mobile object causes the bottleneck.

13. A communication control method, comprising:
executing an identification process of identifying a bottleneck of a communication problem in a service provision method of providing a service from a provision source server to a mobile object;
executing a decision process of deciding a control method in accordance with the bottleneck identified by the identification process; and
executing a notification process of notifying a notification destination as a main control entity that executes control by the control method of the control method decided by the decision process.

14. The communication control method according to claim 13, further comprising, a selection process of selecting the notification destination from among main control entities capable of executing control by the control method in accordance with a correspondence relationship between the control method decided by the decision process and the main control entities capable of executing the control.

15. The communication control method according to claim 14, wherein the selection process includes selecting the notification destination on the basis of the correspondence relationship and at least one of a time required for the control by the control method, an influence range exerted by the control by the control method, and a service quality required for the service.

16. The communication control method according to claim 14, wherein the selection process includes selecting, as the notification destination, a main control entity capable of eliminating a factor that causes the bottleneck from among the main control entities capable of executable in accordance with the correspondence relationship.

17. The communication control method according to claim 14, wherein the selection process includes determining whether or not a factor that causes the bottleneck can be eliminated in a case in which the provision source server is selected as the main control entity capable of executing in accordance with the correspondence relationship, and selecting one notification destination from a management node that manages the provision source server and a plurality of other servers which are different from the provision source server and capable of providing the service in a case in which it is determined that the factor can not be eliminated.

18. The communication control method according to claim 13, wherein
the identification process includes identifying which one of a wireless communication section, the provision source server, and the mobile object causes the bottleneck and incurs the communication problem, and
the decision process includes
deciding execution of predetermined wireless control as the control method in a case in which the wireless communication section causes the bottleneck,
deciding execution of predetermined server control as the control method in a case in which the provision source server causes the bottleneck, and
deciding execution of predetermined mobile object control as the control method in a case in which the mobile object causes the bottleneck.
